(19) United States
(12) Patent Application Publication
(10) Pub. No.: US 2006/0008113 A1
(43) Pub. Date: Jan. 12, 2006

(54) Image processing system and image processing method

(75) Inventors: Yushi Matsukubo, Yokohama-shi (JP); Hiroyuki Yaguchi, Yokohama-shi (JP); Eiichi Nishikawa, Kawasaki-shi (JP); Hiroyuki Tsuji, Yokohama-shi (JP); Shinichi Kato, Kawasaki-shi (JP); Masakazu Kitora, Kawasaki-shi (JP); Kenzou Sekiguchi, Machida-shi (JP); Hiroyoshi Yoshida, Ohta-ku (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/174,498

(22) Filed: Jul. 6, 2005

(30) Foreign Application Priority Data
Jul. 7, 2004 (JP) 2004-200802

(51) Int. Cl. G06K 9/00; G06F 15/00

(52) U.S. Cl. 382/100; 358/1.14

(57) ABSTRACT

This invention provides an image processing system and image processing method which can appropriately provide vector data permitted to reuse by inhibiting information, whose reuse is inhibited or which should not unnecessarily be manipulated from the viewpoint of copyright protection, from being provided to a third party as vector data. An image reading unit (110) inputs image information. A data processing device (115) generates vector data. The data processing device (115) determines whether reuse of the vector data is permitted or inhibited. When it is determined that reuse of the vector data is inhibited, the stored vector data is discarded.

### FIELD OF THE INVENTION

The present invention relates to an image processing system and an image processing method, which convert input image information into vector data reusable by general-purpose document creation application softwares.

### BACKGROUND OF THE INVENTION

Along with a recent growing interest in environmental issues, move to paperless offices has rapidly been promoted. For this purpose, there is conventionally known a document management system which reads paper documents accumulated in binders by using a scanner, converts the read images into portable document format (to be abbreviated as “PDF” hereinafter) data, and accumulates them in an image storage device as a database.

On the other hand, a digital multifunction peripheral (to be abbreviated as an “MFP” hereinafter) with expanded functions records in advance, in recording an image, pointer information in an image storage device, where the image file is present, on the cover page or description information of the document as additional information. When the paper document is to be copied, the original digital file storage location can be detected from the pointer information and reused. When the original information is directly used as the digital file, storage of whole paper documents can be reduced. There is also conventionally known a system which recognizes character information contained in image data obtained by reading a document and linking the information to font data so that reuse/reediting of a paper document is facilitated (e.g., Japanese Patent Laid-Open No. 5-12402).

The former document management system can save a paper document as a PDF file with a compact information amount. However, since the file itself is saved as image information, it is difficult to reuse some objects of the digital document. To reuse the data in the document, graphics or tables must newly be created again by using application software.

The latter MFP can directly access an original digital file corresponding to a digital file created by itself. Hence, the digital data can easily be reused. However, this technique cannot cope with externally acquired new documents and old paper documents whose original digital files cannot be located.

From the viewpoint of copyright protection, some data printed on paper documents without limitations are preferably inhibited from being generated as reusable digital data. If data which needs copyright protection is converted into vector data, it is easily tampered. From the viewpoint of copyright protection, reuse of data which should not be tampered must be inhibited by inhibiting storage of vector data.

### SUMMARY OF THE INVENTION

The present invention has been proposed to solve the conventional problems, and has as its object to provide an image processing system and an image processing method which can appropriately provide vector data permitted to reuse by inhibiting information, whose reuse is inhibited or which should not unnecessarily be manipulated from the viewpoint of copyright protection, from being provided to a third party as vector data.

In order to solve the above problems, according to the present invention, there is provided an image processing system comprising:

an input unit, adapted to input image information;

a vectorization unit, adapted to generate vector data from the image information;

a determination unit, adapted to determine whether reuse of the vector data is permitted or inhibited; and

a control unit, adapted to, when it is determined by the determination unit that reuse of the vector data is inhibited, execute a reuse inhibition process of the vector data to be vectorized by the vectorization unit.

In order to solve the above problems, according to the present invention, there is provided an image processing method comprising:

an input step of inputting image information to an image processing apparatus;

a vectorization step of generating vector data from the image information;

a determination step of determining whether reuse of the vector data is permitted or inhibited; and

a control step of, when it is determined in the determination step that reuse of the vector data is inhibited, executing a reuse inhibition process of the vector data to be vectorized in the vectorization step.

Other feature and advantages of the present invention will be apparent from the following description taken in conjunction with the accompanying drawings, in which like references characters designate the same or similar parts throughout the figures thereof.

### BRIEF DESCRIPTION OF THE DRAWINGS

The accompanying drawings, which are incorporates in and constitute a part of the specification, illustrate embodiments of the invention and, together with the description, serve to explain the principle of the invention.

FIG. 1 is a block diagram showing the arrangement of an image processing system according to an embodiment of the present invention;

FIG. 2 is a block diagram showing the arrangement of an MFP 100 according to the embodiment of the present invention;

FIG. 3 is a flowchart for explaining the image process procedures of the image processing system according to the embodiment of the present invention;

FIG. 4 is a view showing a state wherein read image data of one page is segmented into a plurality of blocks by a block selection process by determining properties;

FIG. 5 is a table showing an example of block information of respective blocks obtained by the block selection process;

FIG. 6 is a view for explaining a point with a maximal curvature;

FIG. 7 is a view for explaining an example wherein an outer outline which is close to an inner outline or another outer outline is expressed as a line with a given width;

FIG. 8 is a flowchart for explaining process procedures executed until vector data are grouped for each graphic object;

FIG. 9 is a flowchart for explaining process procedures of detecting a graphic element;

FIG. 10 is a view showing the data structure of an intermediate data format as a result obtained by converting image data of one page by the block selection process (step S122) and vectorization process (step S124);

FIG. 11 is a flowchart for explaining schematic procedures of the overall conversion process into application data;

FIG. 12 is a flowchart for explaining detailed process procedures of a document structure tree generation process (step S802); and

FIGS. 13A and 13B are views for explaining the outline of a document structure tree.

### DETAILED DESCRIPTION OF THE PREFERRED EMBODIMENT

An image processing system and image processing method according to a preferred embodiment of the present invention will be described below with reference to the accompanying drawings.

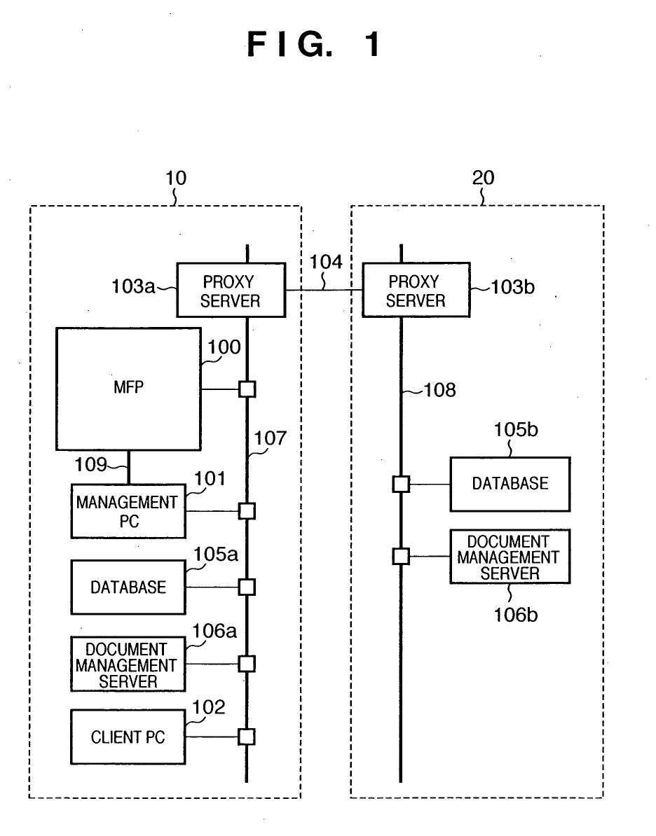

FIG. 1 is a block diagram showing the arrangement of an image processing system according to an embodiment of the present invention. The image processing system shown in FIG. 1 is implemented in an environment in which offices 10 and 20 are connected via an network 104 such as the Internet.

A digital multifunction peripheral (MFP) 100, a management PC 101 which controls the MFP 100, a client PC 102, a document management server 106a, a database 105a, and a proxy server 103a are connected to a LAN 107 formed in the office 10. The MFP 100 can be implemented by, e.g., a copying machine or facsimile apparatus having a multifunction. A document management server 106b, database 105b, and proxy server 103b are connected to a LAN 108 formed in the office 20. The client PC 102 comprises an external storage unit, search image input unit, and search result output unit. The LAN 107 and the LAN 108 in the office 20 are connected to the network 104 such as the Internet via the proxy servers 103a and 103b, respectively.

The MFP 100 in this embodiment is in charge of an image reading process of optically reading a paper document and converting it into an image signal and some of image processes for the read image signal, and inputs the image signal to the management PC 101 via a LAN 109. The management PC 101 can also be implemented by a normal PC and incorporates an image storage unit, image processing unit, display unit, and input unit. The management PC 101 may partially or wholly be integrated with the MFP 100.

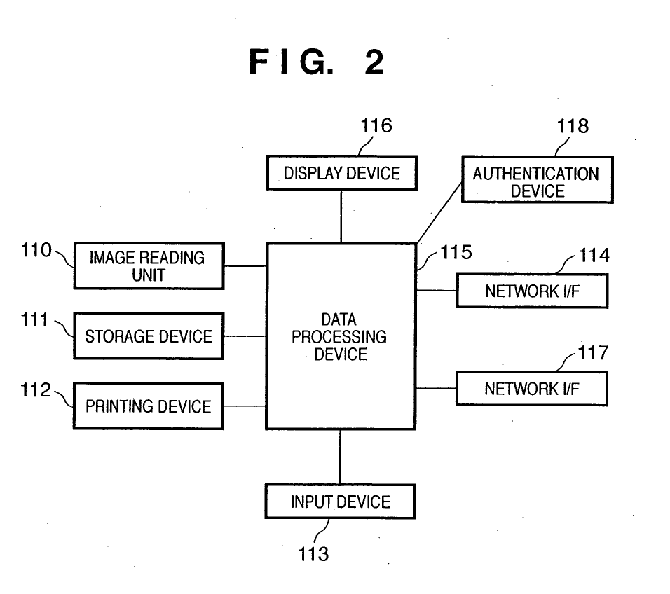

FIG. 2 is a block diagram showing the arrangement of an MFP 100 according to the embodiment of the present invention. An operator's instruction to the MFP 100 is input through an input device 113 such as keys equipped on the MFP 100 or an input device including a keyboard and mouse of a management PC 101. The series of operations is controlled by a controller in a data processing device 115.

Referring to FIG. 2, an authentication device 118 requests the user to input authentication information (e.g., a personal ID or password) and issues for the operator an access permission to the MFP 100 on the basis of the authentication information such as the user's personal ID or password input from the input device 113. If it is determined on the basis of the authentication result by the authentication device 118 that the user is permitted to access, an image reading device 110 including an auto document feeder (to be abbreviated as an “ADF” hereinafter) irradiates a document image on each of one or a plurality of stacked documents with light from an internal light source, forms an image of light reflected by the document on a solid-state image sensing element via a lens, and obtains an image reading signal in the raster order as image information at a resolution of, e.g., 600 dpi from the solid-state image sensing element. When a normal copying function is used, the data processing device 115 executes an image process of that image signal to convert it into a recording signal. In case of a multi-copying process, recording data of one page is temporarily stored in a storage device 111 and sequentially output to a printing device 112, and then images are formed on paper sheets.

Print data output from a client PC 102 is input from a LAN 107 to the MFP 100 and to the data processing device 115 via a network I/F 114 and converted into recordable raster data by the data processing device 115. The raster data is then input to the printing device 112 to form a recording image on a paper sheet.

Status of operation inputs and image data whose process is underway are displayed on a display device 116 of the MFP 100 or on the monitor of the management PC 101 or client PC 102. The storage device 111 stores image data which is read by the image reading device 110 and processed by the data processing device 115. The storage device 111 can also be controlled from the management PC 101. Data exchange and control between the MFP 100 and management PC 101 are done by using a network I/F 117 and a directly connected LAN 109.

[Outline of Reading Process]

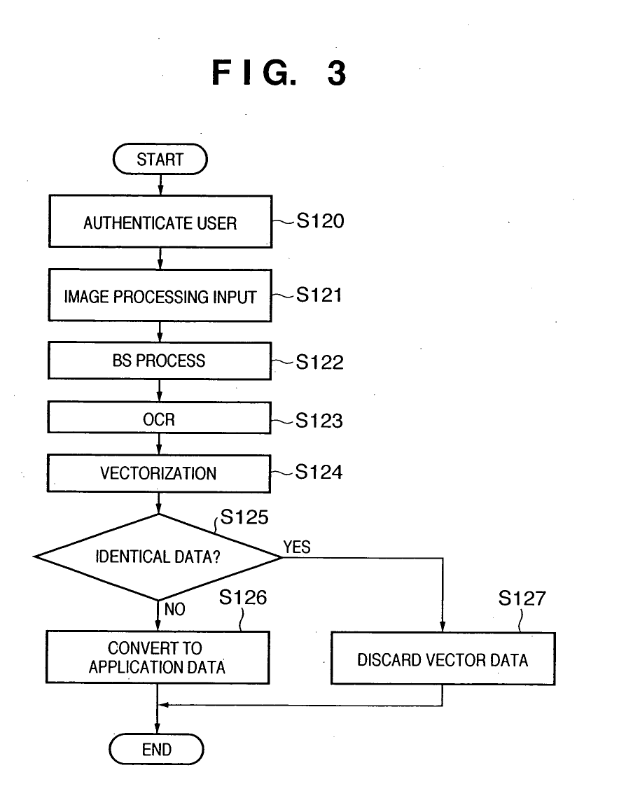

An outline of the entire image process of the image processing system according to the embodiment of the present invention will be described below. FIG. 3 is a flowchart for explaining the image process procedures of the image processing system according to the embodiment of the present invention. A process of acquiring image information by reading a paper document will be described with reference to the flowchart in FIG. 3.

The authentication device 118 executes user authentication on the basis of a user ID or password input from the input device 113 to identify whether the user can access the image processing system (step S120). If it is determined on the basis of the authentication result that the user is permitted to use the MFP 100, the following process can be executed. The image reading device 110 of the MFP 100 is operated to scan one document in a raster order to obtain an, e.g., 8-bit image signal of 600 dpi (image information input process: step S121). This image signal undergoes a pre-process by the data processing device 115 and is saved as image data of one page in the storage device 111.

A CPU in the data processing device 115 or the CPU of the management PC 101 separates text/line art portions and halftone image portions from the image signal stored in the storage device 111. Each text portion is further separated into blocks combined as clusters for the respective paragraphs or tables and graphics formed of lines. The separated parts are segmented. On the other hand, each image portion expressed by halftone is segmented into independent objects for the respective so-called blocks such as an image portion and background portion which are separated into rectangles (BS process: step S122).

An OCR process is executed to recognize the character size, style, and font of the text block (step S123). The data is converted into font data which are visually faithful to characters read by scanning the document so that vector data is generated (step S124). For a table or graphic block formed of lines, the outline is specified to generate vector data. An image block is processed as an individual JPEG file as image information. These vectorization processes are done for the respective objects, and layout information of each object is saved.

With the process in step S124, image information is converted into vector data so that the data is converted into a digital file close to the original digital file.

The data of a logotype (vector data and text data) for copyright protection, which is stored in the storage device 111 in the MFP 100 or the data storage unit of a server (any arrangement can be employed so that an inquiry may be sent to the server, or the data may be stored in the internal HD), is compared with the vector data obtained by the vectorization process in step S124 (step S125). If the two data are different (NO in step S125), it is determined that reuse of the vector data is permitted. The data is converted into application data having a format such as an rtf file processible by general-purpose document creation software and stored in the storage device 111 as a digital file (step S126).

If it is determined on the basis of the comparison result that the two data are identical (YES in step S125), it is determined that reuse of the data is inhibited. The created vector data is discarded (i.e., erased from the system) (step S127). This determination may be done only when two data are completely identical. However, to increase flexibility in determination, even two similar data may be regarded as identical. Since the purpose is to inhibit reuse of data, the data can be stored as image data such as bitmap data anyhow. As the detailed comparison method in step S125, a plurality of sets of dictionary feature vectors equal in number to character types used in general character recognition are prepared in correspondence with character shape types (e.g., font types). A font type is output together with a character code upon matching, thus recognizing the font under copyright protection.

Alternatively, instead of discarding the data inhibited to reuse, a property to inhibit use of its vector data may be given so any person except a specific user cannot use the data. If use of vector data is inhibited for a graphic or line art which should be vectorized, the part is provided to the user as a blank, or use of only bitmap image or image data processed on the basis of the vector data is permitted. This process can be executed not only for graphic or line art data but also for text data. In this embodiment, it is determined after vectorization whether reuse is inhibited. Instead, the contents of data may be determined before vectorization, and vectorization itself may be inhibited.

Each process block will be described below in detail.

The block selection (BS) process in step S122 will be described below.

[Block Selection Process]

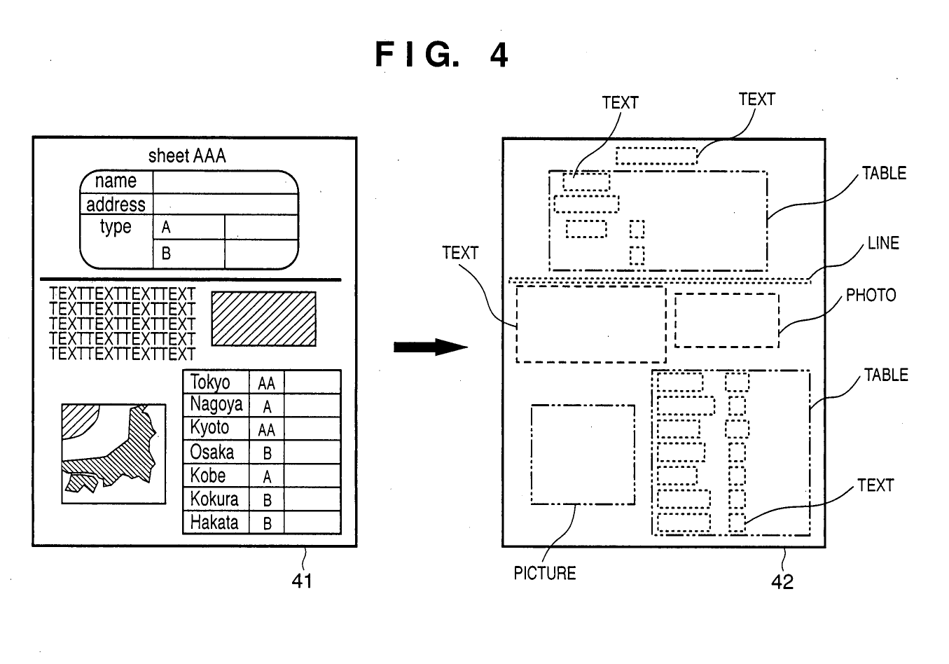

FIG. 4 is a view showing a state wherein read image data of one page is segmented into a plurality of blocks by a block selection process by determining properties. More specifically, in the block selection process, image data 41 of one page read in step S121 is recognized as a cluster 42 of objects, and the properties of the respective blocks are determined as text (TEXT), photo (PHOTO), line (LINE), table (TABLE), and the like so that the image data is segmented into regions (blocks) having different properties.

An embodiment of the block selection process will be described below.

An input image is binarized to monochrome image data. Outline tracking is executed to extract a cluster of pixels surrounded by black pixels. For a black pixel cluster having a large area, outline tracking is executed for white pixels in that cluster to extract a cluster of white pixels. A cluster of black pixels is also extracted recursively from a white pixel cluster having a predetermined area or more. The above-described process is executed for a document having black characters printed on a white background. A document of another type can be processed in the same way by setting the color corresponding to the background to “white” and that corresponding to an object to “black”.

The obtained black pixel clusters are classified into regions having different properties in accordance with their sizes and shapes. For example, a pixel cluster having an aspect ratio of almost 1 and a size in a predetermined range is determined as a pixel cluster corresponding to a character. Furthermore, a portion where neighboring characters regularly line up and can be regarded as a group is determined as a text region. A low-profile pixel cluster is categorized as a line region. A range occupied by a black pixel cluster which includes rectangular white pixel clusters which regularly line up and have a predetermined size or more is categorized as a table region. A region where pixel clusters with indeterminate forms are distributed is categorized as a photo region. A cluster with an arbitrary shape is categorized as a graphic region. With this process, more advanced limits can be imposed for reuse of digital data created by reading one document.

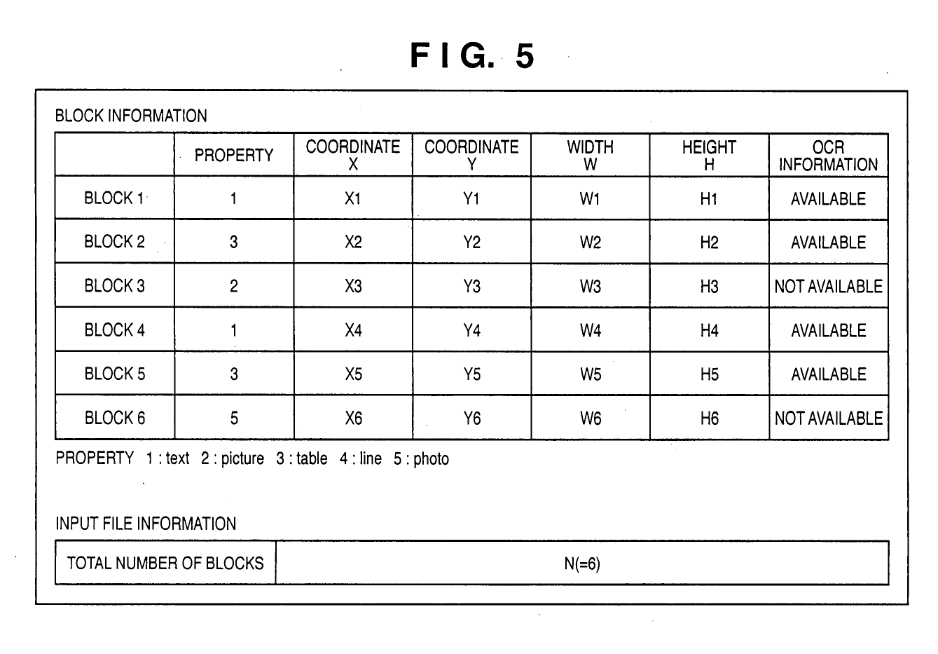

FIG. 5 is a table showing an example of block information of respective blocks obtained by the block selection process. Information of each block shown in FIG. 5 is used as information for vectorization or search to be described later.

[Vectorization Process]

The vectorization process in step S124 in FIG. 3 will be described next. For a text block, a character recognition process is executed for each character.

<<Character Recognition>>

For the character recognition process, in this embodiment, an image extracted for each character is recognized by using one of pattern matching methods, thereby obtaining a corresponding character code. In this recognition process, an observation feature vector obtained by converting a feature obtained from a character image into a several-ten-dimensional numerical value string is compared with a dictionary feature vector obtained in advance for each character type, and a character type with a shortest distance is output as a recognition result. Various known methods are available for feature vector extraction. For example, a method of dividing a character into a mesh pattern and counting character lines in respective meshes as line elements depending on their directions to obtain a (mesh count)-dimensional vector as a feature can be used.

When character recognition is to be executed for a text region extracted by the block selection process (step S122), the writing direction (horizontal or vertical direction) of the region is determined. Lines are extracted in the direction. Then, character images are obtained by extracting characters. In determining the writing direction (horizontal or vertical direction), horizontal and vertical projections of pixel values in that region are calculated. If the variance of the horizontal projection is larger than that of the vertical projection, the region is determined as a horizontal writing region. Otherwise, the region is determined as a vertical writing region.

Decomposition into character strings and characters is done in the following way. For horizontal writing, lines are extracted by using the horizontal projection. In addition, characters are extracted on the basis of the vertical projection for each extracted line. For a vertical writing text region, the relationship between “horizontal” and “vertical” is reversed. The character size can be detected on the basis of the extracted size.

<<Font Recognition>>

A plurality of sets of dictionary feature vectors for the number of character types used in character recognition are prepared in correspondence with character shape types, i.e., font types, and a font type is output together with a character code upon matching, thus recognizing the font of a character.

<<Vectorization of Character>>

In this embodiment, in vectorizing a character, using a character code and font information obtained by the above-described character recognition and font recognition, the information of a character portion is converted into vector data by using outline data prepared in advance. When an input document image is a color image, the color of each character is extracted from the color image and recorded together with vector data.

With the above processes, image information which belongs to a text block can be converted into vector data with a nearly faithful shape, size, and color. Hence, high-quality character data can be handled.

<<Vectorization of Non-Text Portion>>

For a region which is determined as a drawing, line, or table region by the block selection process in step S122, the outline of each extracted pixel cluster is converted into vector data. More specifically, a point sequence of pixels which form an outline is divided into sections at a point considered as a corner, and each section is approximated by a partial line or curve. “Corner” indicates a point where the curvature is maximal.

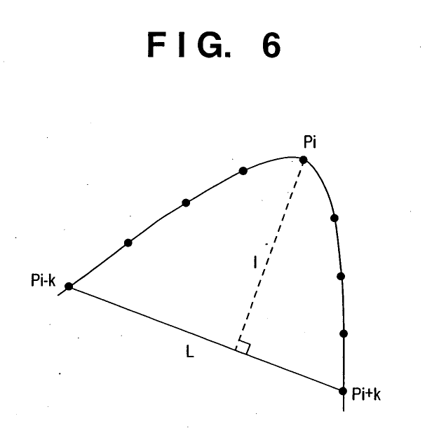

FIG. 6 is a view for explaining a point with a maximal curvature. As shown in FIG. 6, a chord is drawn between points Pi−k and Pi+k separated k points from an arbitrary point Pi to the left and right. A point with a maximal curvature is obtained as a point where the distance between the chord and the point Pi becomes maximal. Let R be the chord length/arc length between Pi−k and Pi+k. Then, a point where the value R is equal to or smaller than a threshold value can be regarded as a corner. Sections obtained by dividing the line at corners can be vectorized by using a method of least squares with respect to a point sequence for a line and a ternary spline function for a curve.

When the subject has an inner outline, it is similarly approximated by a partial line or curve by using a point sequence of a white pixel outline extracted by the block selection process.

As described above, when partial line approximation of outlines is used, the outline of a graphic with an arbitrary shape can be vectorized. When the input document is a color document, the color of each graphic is extracted from the color image and is recorded together with vector data.

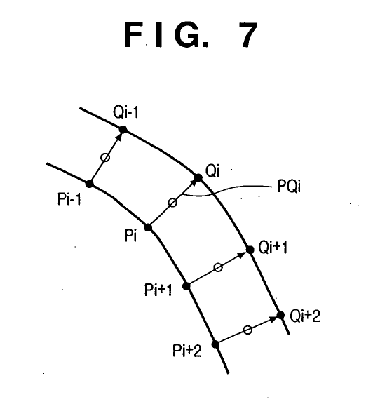

FIG. 7 is a view for explaining an example wherein an outer outline which is close to an inner outline or another outer outline is expressed as a line with a given width. When an outer outline is close to an inner outline or another outer outline in a given section, as shown in FIG. 7, the two outlines can combined and expressed as a line with a given width. More specifically, lines are drawn from points Pi on a given outline to points Qi on another outline such that two corresponding points have the shortest distance. When distances PQi maintain a predetermined value or less on the average, the section of interest is approximated by a line or curve using PQi middle points as a point sequence, and the average value of the distances PQi is set as the width of the line or curve. A line or a table ruled line as a set of lines can efficiently be expressed by vector data as a set of lines having a given width, as described above.

In vectorization using the character recognition process for a text block, a character which has the shortest distance from a dictionary as a result of the character recognition process is used as a recognition result, as described above. When this distance is equal to or larger than a predetermined value, the recognition result does not always match an original character, and a wrong character having a similar shape is often recognized. In this embodiment, therefore, such character is handled in the same manner as a general line art, as described above, and converted into outline data. That is, even a character that causes a recognition error in the conventional character recognition process can be vectorized on the basis of outline data which is visually faithful to image data without being vectorized to a wrong character. In this embodiment, a block which is determined as a photo is not vectorized and is output as image data without any process.

[Graphic Recognition]

A process of grouping vectorized partial lines for each graphic object after the outline of a graphic with an arbitrary shape is vectorized, as described above, will be described below.

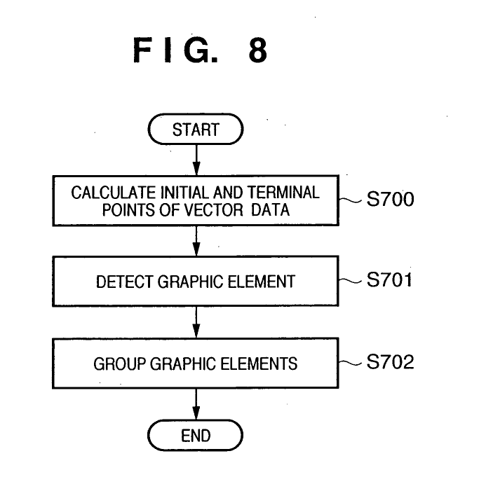

FIG. 8 is a flowchart for explaining process procedures executed until vector data are grouped for each graphic object. Initial and terminal points of each vector data are calculated (step S700). Using the initial and terminal point information of respective vectors, a graphic element is detected (step S701). Detecting a graphic element is to detect a closed graphic formed by partial lines. Detection is executed by applying the principle that each vector which forms a closed shape has vectors coupled to its two ends.

Next, other graphic elements or partial lines present in the graphic element are grouped to set one graphic object (step S702). If any other graphic elements or partial lines are not present in the graphic element, the graphic element is set as a graphic object.

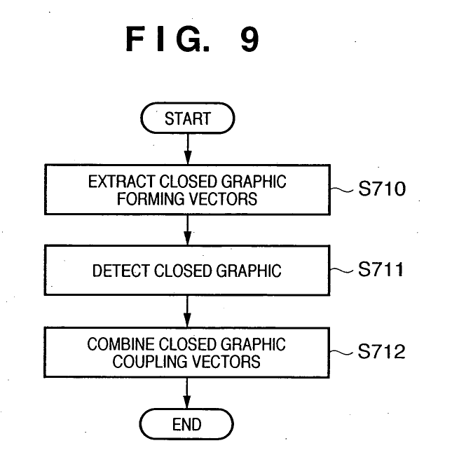

FIG. 9 is a flowchart for explaining process procedures of detecting a graphic element. Unwanted vectors each having two ends unconnected to other vectors are removed from vector data to extracted closed graphic forming vectors (step S710). The initial point of a vector of interest of the closed graphic forming vectors is set as a start point, and vectors are sequentially tracked clockwise. This tracking is executed until returning to the start point. All passing vectors are grouped as a closed graphic which forms one graphic element (step S711). All closed graphic forming vectors present in the closed graphic are also grouped. The initial point of a vector which is not grouped yet is set as a start point, and the above process is repeated. Finally, of the unwanted vectors removed in step S710, those which join the vectors grouped as the closed graphic in step S711 are detected and grouped as one graphic element (step S712).

With the above process, a graphic block can be handled as an independently reusable graphic object.

[Conversion Process into Application Data]

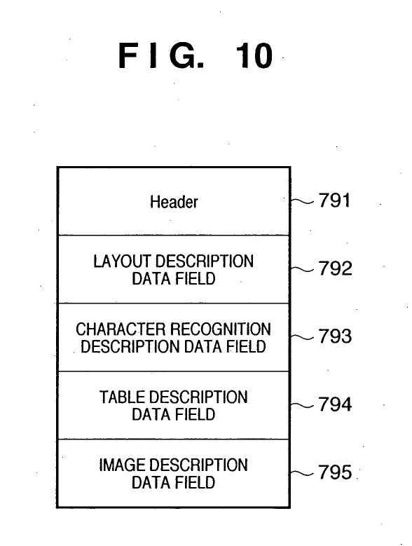

FIG. 10 is a view showing the data structure of a file having an intermediate data format as a result obtained by converting image data of one page by the block selection process (step S122) and the vectorization process (step S124). The data format shown in FIG. 10 is called a document analysis-output format (DAOF). That is, FIG. 10 shows the DAOF data structure.

Referring to FIG. 10, reference numeral 791 denotes a Header which holds information about document image data to be processed. Reference numeral 792 denotes a layout description data field which holds property information and rectangular block address information of blocks in the document image data, which are recognized for the properties-such as TEXT (text), TITLE (title), CAPTION (caption), LINEART (line-art), PICTURE (natural image), FRAME (frame), and TABLE (table).

Such DAOF data itself is sometimes saved as a file in place of intermediate data. However, in the state of a file, individual objects cannot be reused by a general document creation application. A process of converting DAOF data into application data (step S126) will be described next in detail.

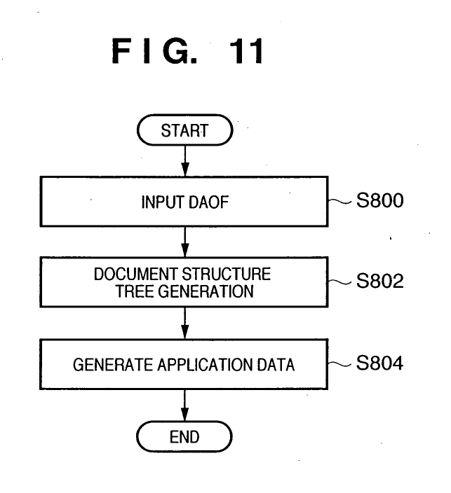

FIG. 11 is a flowchart for explaining schematic procedures of the overall conversion process into application data. DAOF data is input (step S800). A document structure tree serving as a base of application data is generated (step S802). Actual data in the DAOF are input on the basis of the generated document structure tree to generate actual application data (step S804).

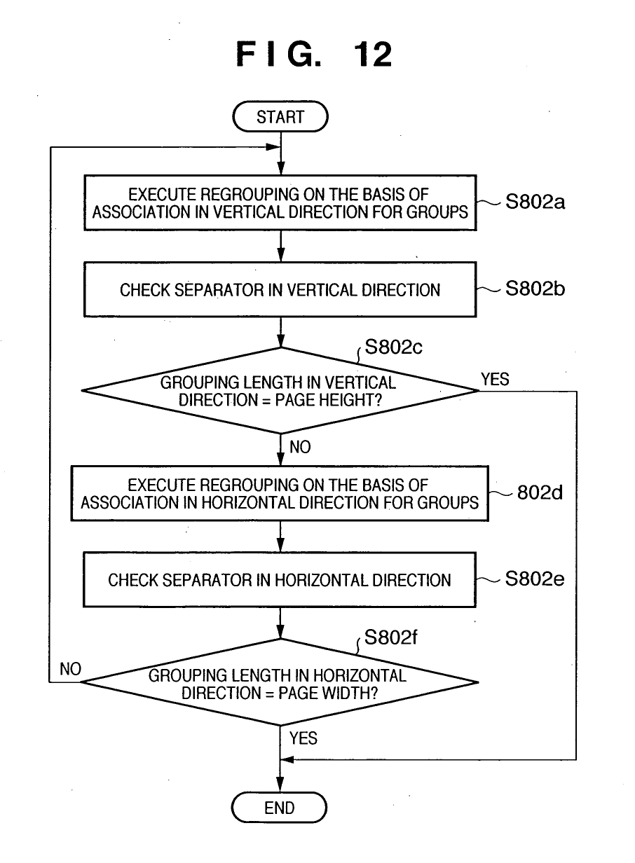

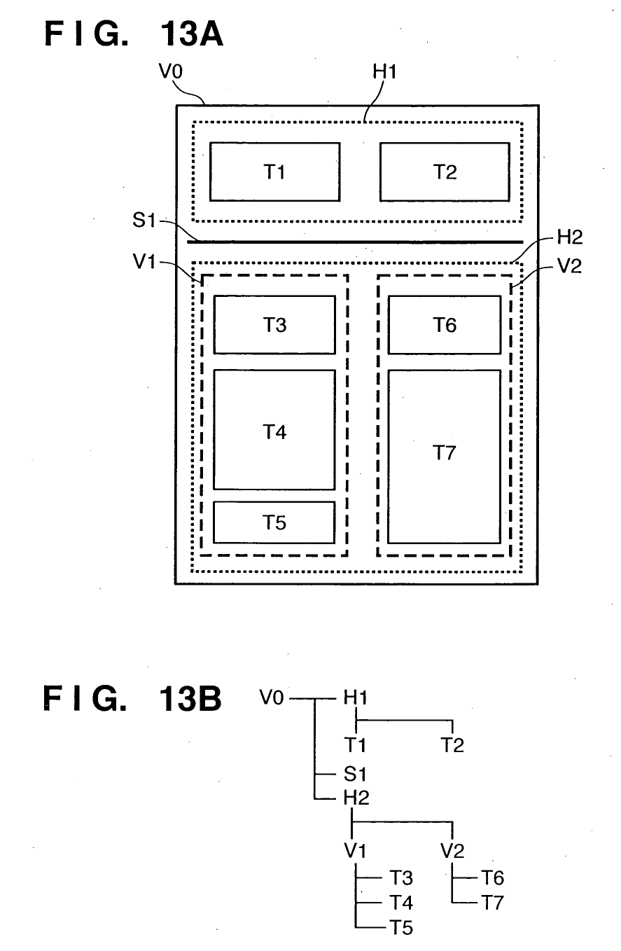

FIG. 12 is a flowchart for explaining detailed process procedures of the document structure tree generation process (step S802). FIGS. 13A and 13B are views for explaining the outline of the document structure tree. As the basic rule of overall control, the flow of processes transits from a microblock (single block) to a macroblock (a set of blocks). In the following description, a block indicates both a microblock and macroblock.

Regrouping is done for blocks on the basis of association in the vertical direction (step S802a). Immediately after the start, determination is done for each microblock. Association can be defined when the distance between blocks is small, and blocks widths (heights in case of the horizontal direction) almost equal. The pieces of information of distances, widths, and heights are extracted with reference to the DAOF.

FIG. 13A shows an actual page configuration, and FIG. 13B shows the document structure tree of the page. As a result of grouping in step S802a, T3, T4, and T5 form one group V1, and T6 and T7 form one group V2. These groups are generated as groups which belong to the same layer.

The presence/absence of a vertical separator is checked (step S802b). Physically, a separator is an object which has a line property in the DAOF. Logically, a separator is an element which explicitly divides blocks in an application. When a separator is detected, the groups are re-divided in the same layer.

It is determined by using the group length whether no more divisions can be present (step S802c). For example, it is determined whether the grouping length in the vertical direction equals the page height. If the group length in the vertical direction equals the page height (YES in step S802c), document structure tree generation is ended. In, e.g., the structure shown in FIGS. 13A and 13B, no separator is present, and the group height does not equal the page height. Since No in step S802c, the flow advances to step S802d.

In step S802d, regrouping is done for blocks on the basis of association in the horizontal direction. Even in this regrouping, the first determination immediately after the start is done for each microblock. Definitions of association and its determination information are the same as those in the vertical direction. In, e.g., the structure shown in FIGS. 13A and 13B, T1 and T2 generate a group H1, and V1 and V2 generate a group H2. The group H1 is generated as a group one level higher than T1 and T2. The group H2 is generated as a group one level higher than V1 and V2. The groups H1 and H2 belong to the same layer.

The presence/absence of a horizontal separator is checked (step S802e). Since a separator S1 is present in FIGS. 13A and 13B, it is registered in the tree so that the layers H1, S1, and H2 are generated. It is determined by using the group length whether no more divisions are present (step S802f). For example, it is determined whether the grouping length in the horizontal direction equals the page width. If the group length in the horizontal direction equals the page width (YES in step S802f), document structure tree generation is ended. If the group length in the horizontal direction does not equal the page width (NO in step S802f), the flow returns to step S802a to repeat the process from association check in the vertical direction in the layer higher one level. In, e.g., the structure shown in FIGS. 13A and 13B, since the division width equals the page width, the process is ended. Finally, an uppermost layer V0 representing the entire page is added to the document structure tree.

After the document structure tree is completed, application data is generated in step S804 on the basis of the information of the document structure tree. A practical example for the structure shown in FIGS. 13A and 13B will be explained below.

Since H1 includes the two blocks T1 and T2 in the horizontal direction, it is output as two columns. Internal information of T1 (text or image as the character recognition result with reference to the DAOF) is output. Then, a new column is set, and internal information of T2 is output. After that, S1 is output. Since H2 includes the two blocks V1 and V2 in the horizontal direction, it is output as two columns. Internal information of V1 is output in the order of T3, T4, and T5. Then, a new column is set, and internal information of V2 is output in the order of T6 and T7. In this way, the conversion process into application data can be done. With this process, the vectorized object can be reused by existing document creation application software.

As described above, in this embodiment, when vector data is generated, it is determined whether reuse of the data is permitted or inhibited. Even when the data can be reused, the number of times of reuse may be limited by the system administrator by adding a tag representing the reuse count to the vector data as additional information. For example, the number of times of reuse of vector data is counted. When the count reaches a predetermined value, reuse of the vector data may be limited. To limit reuse, for example, the vector data may be discarded, as described above. With this arrangement, even reusable vector data can be prevented from being reused without limitations.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

According to the present invention, vector data permitted to reuse can appropriately be provided by inhibiting information, whose reuse is inhibited or which should not unnecessarily be manipulated from the viewpoint of copyright protection, from being provided as vector data.

As many apparently widely different embodiments of the present invention can be made without departing from the spirit and scope thereof, it is to be understood that the invention is not limited to the specific embodiments thereof except as defined in the

What is claimed is:

1. An image processing system comprising:
an input unit, adapted to input image information;
a vectorization unit, adapted to generate vector data from the image information;
a determination unit, adapted to determine whether reuse of the vector data is permitted or inhibited; and
a control unit, adapted to, when it is determined by said determination unit that reuse of the vector data is inhibited, execute a reuse inhibition process of the vector data to be vectorized by said vectorization unit.

2. The system according to claim 1, further comprising a storage unit, adapted to store the vector data vectorized by said vectorization unit,
wherein when it is determined by said determination unit that reuse of the vector data is inhibited, said control unit discards the vector data stored in said storage unit.

3. The system according to claim 2, further comprising a holding unit, adapted to hold information about vector data inhibited to reuse,
wherein when the vector data stored in said storage unit and the information held by said holding unit can be regarded as identical, said determination unit determines that reuse of the vector data stored in said storage unit is inhibited.

4. The system according to claim 3, wherein
the vectorization unit generates vector data containing character code information of character information extracted from the image information,
said holding unit holds character code information of character information inhibited to reuse, and
when the character code information contained in the vector data and the character code information held by said holding unit are identical, said determination unit determines that reuse of the vector data stored in said storage unit is inhibited.

5. The system according to claim 1, further comprising a format conversion unit, adapted to convert the image information into a format processible by predetermined document creation software.

6. The system according to claim 1, further comprising a segmentation unit, adapted to segment the image information into a plurality of objects,
wherein said determination unit determines, independlety for each of the objects segmented by said segmentation unit, whether reuse of the vector data is permitted or inhibited.

7. The system according to claim 1, further comprising
a count unit, adapted to count the number of times of reuse of the vector data, and
a limitation unit, adapted to limit reuse of the vector data when the number of times counted by said count unit reaches a predetermined value.

8. The system according to claim 1, further comprising
a request unit, adapted to request a user to input authentication information before input of the image information by said input unit, and
an identification unit, adapted to identify on the basis of the input authentication information whether the user is permitted to access the image processing system,
wherein said input unit inputs the image information on condition that said identification unit identifies that the user is permitted to access.

9. The system according to claim 1, wherein said input unit inputs the image information obtained by optically reading a paper document.

10. The system according to claim 1, further comprising a storage unit, adapted to store the image information input by said input unit,
wherein when it is determined by said determination unit that reuse of the vector data is inhibited, said control unit makes the image information usable and the vector data unusable, and when it is determined by said determination unit that reuse of the vector data is permitted, said control unit makes the vector data reusable.

11. An image processing method comprising:
an input step of inputting image information to an image processing apparatus;
a vectorization step of generating vector data from the image information;
a determination step of determining whether reuse of the vector data is permitted or inhibited; and
a control step of, when it is determined in the determination step that reuse of the vector data is inhibited, executing a reuse inhibition process of the vector data to be vectorized in the vectorization step.

12. A program to cause a computer to execute:
an input procedure of inputting image information;
a vectorization procedure of generating vector data from the image information;
a determination procedure of determining whether reuse of the vector data is permitted or inhibited; and
a control procedure of, when it is determined in the determination procedure that reuse of the vector data is inhibited, executing a reuse inhibition process of the vector data to be vectorized in the vectorization procedure.

13. A computer-readable recording medium storing a program of claim 12.
